(19) United States
(12) Patent Application Publication
(10) Pub. No.: US 2002/0062182 A1
(43) Pub. Date: May 23, 2002

(54) Support system and method for recovering a train, and information transmitting system in a train

(76) Inventors: Yutaka Sato, Hitachi (JP); Masahiro Nagasu, Hitachinaka (JP); Dai Watanabe, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/791,604

(22) Filed: Feb. 26, 2001

(30) Foreign Application Priority Data
Nov. 22, 2000 (JP) 2000-356165

(51) Int. Cl. G06F 19/00

(52) U.S. Cl. 701/19; 701/29

(57) ABSTRACT

A support system for recovering a train in which the amount of information to be transmitted from the train to a train-running management system and maintenance factory can be reduced. At the time of transmitting information on a failure from the train to a plurality of ground facilities, information is analyzed and processed in the train according to different transmission destinations, and necessary information is transmitted to the ground facilities. Thereby the amount of communication between the ground facilities and train can be made small and the amount of information to be processed in the ground facilities can be reduced.

### BACKGROUND OF THE INVENTION

The present invention relates to a support system and method for recovering a fault of a device in a train at an early stage, and also to an information transmitting system in the train.

Since trains used by many people have a character of public servant strongly, their disturbed train service schedule causes users to be greatly influenced. To avoid this, there has been installed a highly-reliable system that can minimize such train schedule disturbance caused by a failure. However, it is impossible to completely avoid such a train failure. To this end, a system is demanded which can recover the train at an early stage once the train became faulty.

For the purpose of attaining smooth train running, a train-running management system is usually provided on a ground side. In a normal time, the train-running management system monitors the running condition of the train, power, facilities associated therewith to support the train running on schedule. Once the train running is disturbed by some cause, the system helps recover the train by arranging for the adjustment of the train-running time schedule, the repair of the faulty car, car exchange, etc. Meanwhile, a maintenance factory for the train car carries out car inspection, repair or exchange arrangement while making contact with the train-running management system.

Techniques for quickly transmitting information on a train failure to the train-running management system and maintenance factory on the ground side are disclosed in JP-A-5-56506 and JP-A-10-76952. In these techniques, a train, a train-running management system, and a maintenance factory are connected by a network to transmit information about the failure in the train in real time and to recover the train from the failure at an early stage.

### SUMMARY OF THE INVENTION

On a train, pluralities of electrical devices including main converters to drive motors, brake controllers and auxiliary power supply units are mounted. And various sensors are attached to the respective devices to grasp the states of the devices. Such sensors are highly useful in detecting a fault in the devices. Such information becomes enormous for a single train of cars. The train-running management system receives such enormous information from the train. When the system manages all trains in a section under its control, a total amount of such information becomes massive. Direct communication of such massive information between the train and ground side system requires its communication system to have a large capacity and a high communication speed.

Further, the train-running management system also processes a large amount of information simultaneously for monitoring of the running states of trains, providing information to stations or trains, collecting information about rainfall, incidents or calamities. When it is desired for the train-running management system to directly receive and analyze information on the train devices, the system must have a processing capability remarkably improved over the prior art.

The aforementioned prior arts require reinforcement of communication lines and substantial reinforcement of the information processing ability of ground facilities.

It is therefore an object of the present invention to collect train failure information and to transmit necessary information to ground facilities with a less transmission amount.

A major feature of the present invention is to provide in a train a means for processing collected information according to different communication and a communication device for sending the different processed information to associated train-running management system and maintenance factory respectively.

In accordance with a desired aspect of the present invention, an information analyzer is provided for analyzing the influences of a failure in a train on the operation of the train, and a communication device is provided for transmitting the analyzed information and/or different processed information to associated train-running management system and maintenance factory respectively.

In this manner, the burden of communication device and ground facilities can be lightened by transmitting minimum information necessary for each of the different ground facilities.

The aforementioned information may also be transmitted even to a communication device of train device manufacturers.

In accordance with another aspect, the present invention is featured by including steps of transmitting information indicative of occurrence of a failure in a train toward a plurality of ground facilities, steps of processing collected information according to different communication partner, and steps of transmitting the processed information to the plurality of associated ground facilities according to the different communication partner respectively.

It is also desirable to add steps of analyzing the influences of a failure in a train on the operation of the train, and transform the above steps of transmitting into steps transmitting the analyzed information and/or different processed information to the plurality of associated ground facilities according to the different communication partner respectively.

In this manner, the failure can be quickly apprised to the ground facilities and thereafter detail information of the failure can be transmitted thereto, thus enabling smooth coping with the failuare on the ground side.

By transforming the steps of processing the information, into the steps of processing the analyzed information, the amount of information to be transmitted for each transmission destination can be made small.

### BRIEF DESCRIPTION OF THE DRAWINGS

FIG. 1 is a schematic representation showing a general configuration of a train recovery support system in accordance with an embodiment of the present invention;

FIG. 2 is a block diagram of devices mounted on a train;

FIG. 3 is a flowchart for explaining flows of operations of the train recovery support system of the first embodiment of the present invention when a failure took place;

FIG. 4 is a flowchart for explaining flows of operations of a train-running management system of the train recovery support system of the first embodiment of the present invention when a failure took place;

FIG. 5 is a flowchart for explaining entire flows of operations of the first embodiment of the present invention when a specific failure took place;

FIG. 6 is a flowchart for explaining flows of operations of a train recovery support system in accordance with a second embodiment of the present invention when a failure took place; and

FIG. 7 is a flowchart for explaining entire flows of operations of the second embodiment of the present invention when a specific failure took place.

### DETAILED DESCRIPTION OF THE EMBODIMENTS

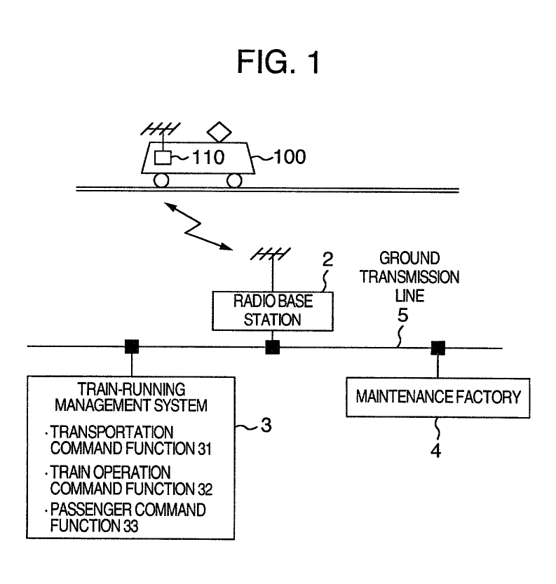

FIG. 1 shows an overall configuration of a train recovery support system in accordance with an embodiment of the present invention. A communication device 111 is mounted on a train 100 to communicate with a radio base station 2 wirelessly. The radio base station 2 is connected to a train-running management system 3 and a maintenance factory 4 by a ground transmission line 5 to realize mutual information communication. The train-running management system 3 has a transportation command function 31 for monitoring the running state of the train and managing the running of the train when the train schedule was disturbed, a passenger command function 32 for offering passenger services such as announcement of apposite information to passengers by a station authority or conductor, and a train operation command function 33 for issuing a command relating to an advice or arrangement of train car exchange in case of a failure.

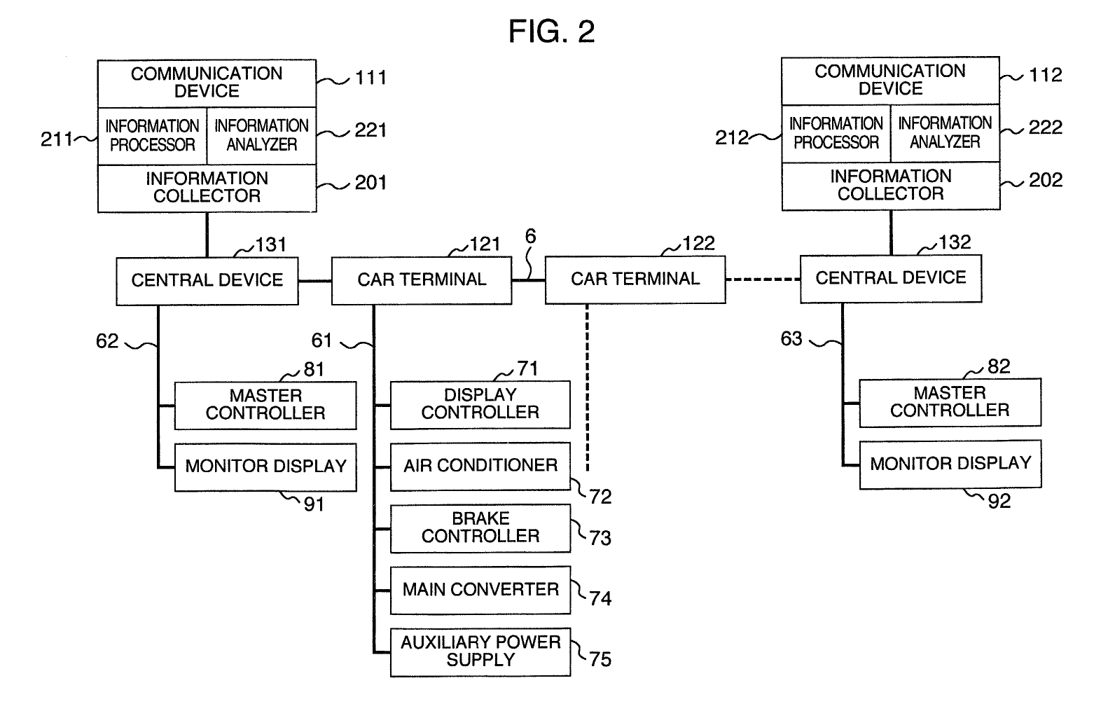

FIG. 2 shows an arrangement of an information collection and communication system of the train 100 in the embodiment of the present invention. Car terminals 121, 122, . . . for generally controlling transmission of information on devices of the associated cars of the train 100 are installed on the respective cars of the train. Central devices 131 and 132 for mainly performing general control of transmission of information on train running control are installed on leading and trailing ones of the cars. The central devices, which are connected by a main transmission line 6, can mutually transmit information. The car terminal 121 or 122 of each car is connected with car-mounted devices by branch transmission line 61. The car-mounted devices include a display controller 71 for controlling destination display and so on, an air conditioner 72, a brake controller 73, a main converter 74 for controlling of driving operation of the train, and an auxiliary power supply 75 for powering the air conditioner and a display controller.

Connected to the central devices 131 and 132 are master controllers 81 and 82 as train main controllers by branch transmission lines 62 and 63 as well as monitor displays 91 and 92 for displaying the state of the train thereon and for controlling air conditioning or display by various switches, respectively. Further connected to the central devices are information collection units 201 and 202 for collecting and storing information in the car-mounted devices, information processing units 211 and 212 for processing the collected information, information analyzing units 221 and 222 for analyzing the collected information, and communication units 111 and 112 for transmitting the processed data and/or analyzed data to ground facilities, respectively. The state information collected in the information collecting units 201 and 202 are processed by the information processing units 211 and 212 and then transmitted, or are analyzed by the information analyzing units 221 and 222 and then both of the processed and analyzed results are transmitted, respectively. Alternatively, the collected information are analyzed by the information analyzing units 221 and 222, and then transmitted after being processed by the information processing units 211 and 212. For this reason, only information necessary for the respective communication partner can be transmitted, which will be explained in detail.

In a normal state, the central device 131 and its associated devices connected thereto in the leading car are active for train control, while the central device 132 and its associated devices connected thereto in the trailing car are used as a backup.

When a train driver operates the master controller 81 or monitor display 91, its command is transmitted to the respective car-mounted devices 71 to 75 via the main transmission line 6 and car terminals 121 and 122. In response to the command, the respective car-mounted devices 71 to 75 are operated and output operational states of the associated devices. The state information are transmitted to the monitor displays 91 and 92 via the main transmission line 6 and are displayed on the displays as the operational states of the associated devices. Simultaneously with it, the state information are stored in the information collecting units 201 and 202.

Assume now that a failure took place in a part of the car-mounted devices 71 to 75. Then the system can detect the failure on the basis of the state information on faulty one of the car-mounted devices. When the device breaks down including its communication function, the system can detect the failure by stop of the state information transfer from the faulty device. The detection of the failure causes the communication units 111 and 112 to transmit the fact to the ground facilities. The ground facilities as communication partner include the train-running management system 3 on the train, the maintenance factory 4, or the device manufacturer (not shown).

As a matter of course, the different ground facilities require different information. In the case of the train-running management system 3, for example, its most important role is to realize smooth running operation of the train and to this end, to know the degree of damage of the ability of the train caused by the failure is important. In the case of the maintenance factory 4 or device manufacturer, its important role is to know the cause of the failure or how to recover it.

In this embodiment, the information of the information collecting units 201 and 202 are processed by the information processing units 211 and 212 and then transmitted. Or the information are concurrently analyzed by the information analyzing units 221 and 222 and then the processed and analyzed information are transmitted. Alternately the state information from the car-mounted devices are analyzed by the information analyzing units 221 and 222 and thereafter are processed by the information processing units 211 and 212 for transmission. As a result, only information necessary for the respective communication partner can be transmitted thereto. More specifically, a device name of the faulty device or a variable name of a state indicating a fault value such as wrong temperature or overcurrent is transmitted to the train-running management system 3. Data on the degree of train running performance, such as accelerating or decelerating ability influenced by the failure, a delay time up to the next station, the number of passengers on the train estimated from the weight of the train, can also be transmitted to the system on the basis of the analysis of data at the time of the failure. It is also desirable to transmit to the maintenance factory the state information of the faulty device after or before its failure as it is. Similarly to the maintenance factory, the similar data may be transmitted even to the device manufacturer, or data may be transmitted to the system from the maintenance factory. When the ground facilities decide the necessity of more data, the facilities demand the data from the train 100. In response to this demand, the information processing units 211 and 212 or information analyzing units 221 and 222 process and analyze the state information, and the communication units 111 and 112 transmit the processed and analyzed information.

In this embodiment, information required by the respective communication partner are processed in the train, processed and analyzed concurrently, or analyzed and processed in the train, and then transmitted. For this reason, the amount of communication between the ground and train sides can be remarkably are reduced and thus transmission can be realized with a small capacity of communication line.

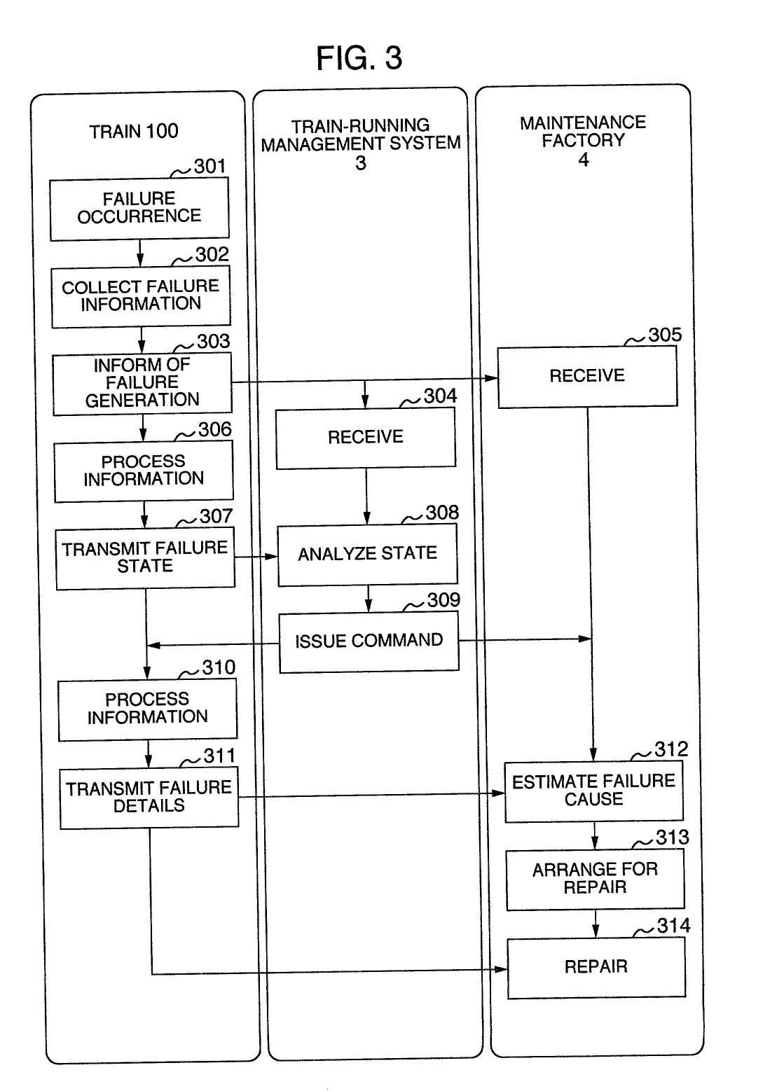

FIG. 3 shows a flowchart for explaining flows of operations of the train recovery support system in accordance with the first embodiment of the present invention when a failure took place. In the flowchart of the first embodiment, the information analyzing units 221 and 222 in FIG. 2 are not used. The respective car-mounted devices 71 to 75 on the train always output the states of their devices, while the information collecting units 201 and 202 collect and store these state information therein. Accordingly, when a failure took place in the devices in a step 301, failure information from the faulty device is transmitted in a step 302, whereby the system can detect the failure occurrence. Even when the communication function of the device became faulty, the failure can be detected by stop of the communication. When the failure is detected, the accident occurrence is first broadcast to the ground facilities in a step 303, so that the train-running management system 3 and maintenance factory 4 on the ground side can receive the failure occurrence in steps 304 and 305 respectively. In a step 306, next, information necessary for the train-running management system 3 of the device information stored in the train is processed. The information required by the train-running management system 3 is for estimation of the influences by the failure and includes the name of the faulty device and the faulty location. The processed information is then transmitted to the train-running management system 3 in a step 307. Details of the operation of the train-running management system 3 include the operation of a step 308 for analyzing the state of the failure and the operation of a step 309 for issuing a command indicative of car exchange or repair in the train in question, a train coming after the faulty train, a next station, the maintenance factory 4, etc., which will be explained in detail later.

The train 100 transmits the information to the train-running management system 3 and thereafter, processes the information necessary for the maintenance factory 4 in a step 310 of the stored device information. The information required by the maintenance factory 4 is for the purpose of the device repair, and includes detailed information indicating the state of the device before and after the failure occurrence therein. In a step 311, the train transmits the necessary information to the maintenance factory 4. The maintenance factory 4 estimates the cause of the failure on the basis of the received information in a step 312. If a similar failure may possibly occur even in the other devices in operation normally, then the maintenance factory can demand the information of the other devices from the train 100. If the maintenance factory finds a sign of failure even in the other main converter, the factory issues a command to the train-running management system to stop the train immediately (not shown). Thereafter, in a step 313, the maintenance factory adjusts parts necessary for the failure removal and a factory operating schedule on the basis of the estimated failure cause. As soon as the faulty train car is transported to the maintenance factory, the factory advances its repairing works in a step 314.

At this time, since the failure information is previously sent to the maintenance factory in the step 303 to 305, the repairing works can be efficiently advanced. In this connection, it is desirable to store the actual failure state and the previously-sent state information in the form of a database. This can facilitate the failure estimation and repair when a next similar failure took place.

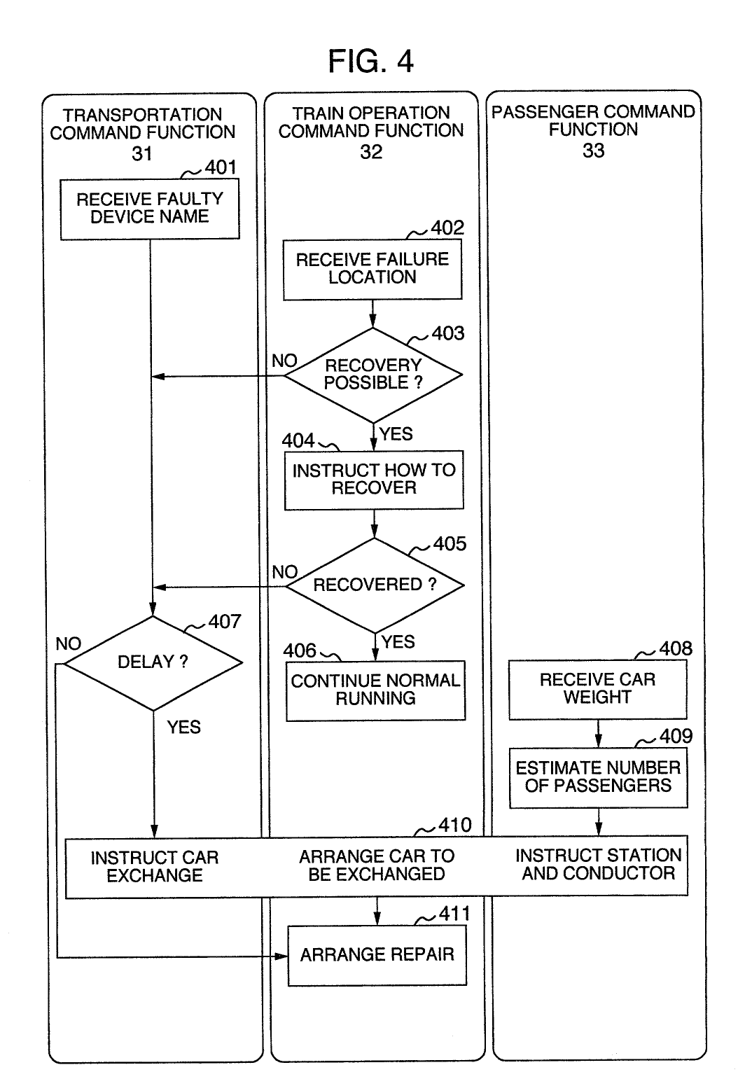

FIG. 4 shows a flowchart explaining flows of specific operations of the first embodiment of FIG. 3 when a failure took place. In the drawing, the functions of the train-running management system 3 are illustrated as divided into the transportation command function 31, passenger command function 32 and train operation command function 33. The transportation command function 31 receives information indicative of the faulty device from the train 100 in a step 401. The passenger command function 32 receives information indicative of which part of the faulty device in a step 402. Next the passenger command function 32 estimates the recovery possibility from the faulty location in a step 403. For the estimation, the past stored failure data may be used. Or the train-running management system 3 may communicate with the maintenance factory 4 to ask its estimation. If the failure is light to such an extent as to be removable during running of the train, then the passenger command function 32 sends a proper advice of how to remove the failure from the train (for example, by pushing a reset button) in a step 404. When the failure was removed by the above operation in a step 405, the train is continued to run normally in a step 406. In the case of no recovery possibility or the failure cannot be removed, the transportation command function 31 assesses a train delay in a step 407. In the case of light failure such as the train does not delay, the train is continued to run, and a repair arrangement (step 411) for its repair is made after service running of the train. In the case of the a train delays, the command functions 31 to 33 arrange the car replace in a common step 410. The passenger command function 32 arranges to replace exchange the car and also to repair the faulty car in a step 411. The transportation command function 31 selects a station wherein the faulty car is replaced and sends notice to the train. The transportation command function 31 also instructs later trains its time schedule change. The train operation command function 33 receives information indicating the car weight from the train in a step 408 and estimates the number of passengers on the car on the basis of the received information in a step 409. And the train operation command function 33 provides a conductor on the train and the station wherein the car is replaced with smooth car replacement by contacting them in the step 410.

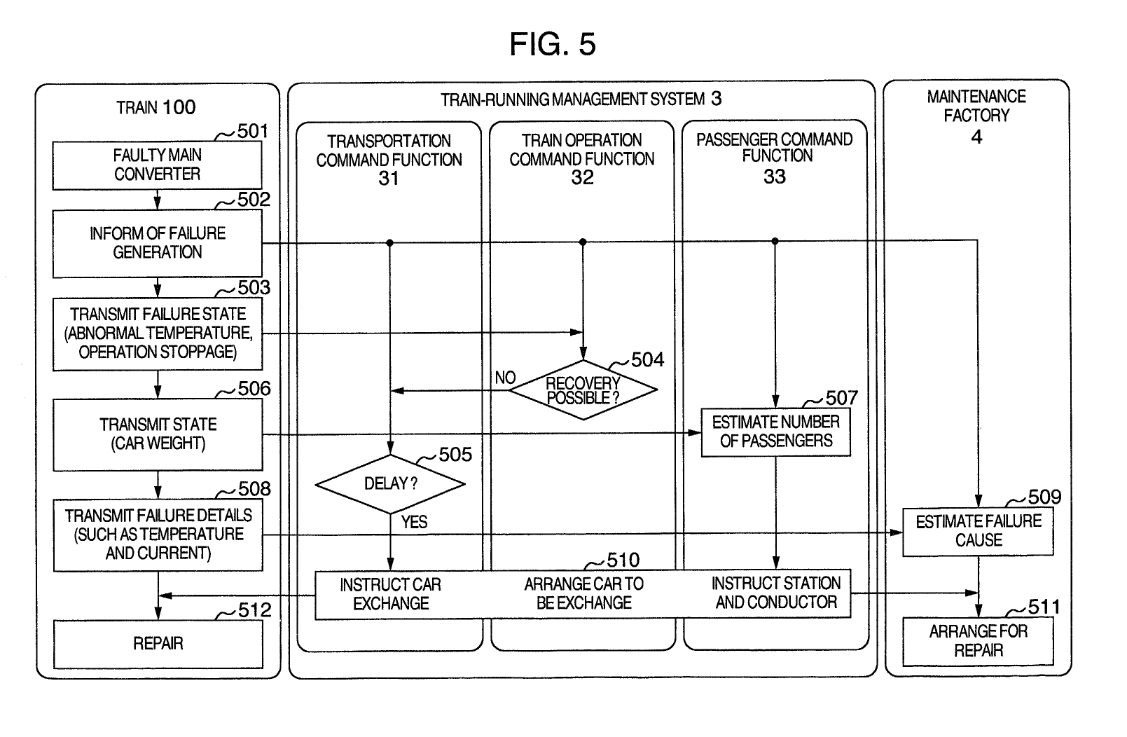

FIG. 5 is a flowchart for explaining entire flows of operations of the first embodiment when a failure took place. It is assumed in a step 501 that one of four main converters mounted on a train had a temperature failure and the operation thereof was stopped, and then, the normal train running is harmed. Then device information from the faulty main converter indicates the temperature failure and output stoppage, and thus the failure occurrence is detected. As soon as detecting the failure, the train transmits informations indicating the faulty main converter to the command functions of the train-running management system 3 and to the maintenance factory 4 in a step 502. In response to the received information, the respective command functions 31 to 33 of the train-running management system 3 and the maintenance factory 4 prepares to cope with the failure. The train 100, on the basis of the collected information, transmits informations indicating that the temperature is fault value and thereafter the device stopped as the failure state, to the passenger command function 32 in a step 503. The passenger command function 32 estimates the recovery possibility according to the received information in a step 504. For the estimation, the past stored failure information may be used. Or the passenger command function 32 may contact with the maintenance factory 4 to ask its decisions. If the recovery possibility is high, the passenger command function 32 sends an apposite advice to the train. In the case of the illustrated example, since the main converter output is stopped simultaneously with the temperature failure, the passenger command function 32 decides that the main converter is damaged and cannot be recovered. And the transportation command function 31 decides running delay of the train 100 in a step 505. In this case, one of the four main converters stops its operation and thus the overall running ability of the train is reduced to 75%. For this reason, the transportation command function 31 decides that the train delays. Thus the respective command functions arranges the car replacement in a common step 510. The passenger command function 32 arranges a car to replace. The transportation command function 31, on the basis of the degree of the train delay and to the required time to arrange the replace car, selects a station wherein the car is replaced and contacts with the station. The transportation command function 31 also instructs later trains the time schedule change. The train operation command function 33 receives information about the weight of the car from the train and estimates the number of passengers on the car in a step 507. And the train operation command function 33 assists the smooth car replacement by contacting with a conductor of the train and the station wherein the car is replaced in the step 510.

The train 100, according to the stored device information, transmits to the maintenance factory 4, such as the information about normal-state data of the faulty main converter before faulty including its normal temperature, current, and voltage in a step 508. The maintenance factory 4, according to the received normal-state data, estimates the cause of the failure in a step 509. In this case, the maintenance factory 4 estimates whether the failure took place in the cooling system of the main converter or the failure was caused by a wrong running pattern based on the malfunction in the control system. When there may be a possibility that a similar failure takes place even in the other main converters operating now normally, the maintenance factory 4 requires the train to send the information about the other main converters. If there is a possibility of failure even in the other main converters, the maintenance factory 4 issues a command to the train and train-running management system to immediately stop the train. The maintenance factory 4 may also transmit an estimated result of the failure cause to the passenger command function to help the passenger command function to decide the recovery possibility (in the step 604). And in a step 511, the maintenance factory 4, on the basis of the estimated failure cause, arranges repair, such as obtaining parts necessary for the failure removal and adjustment of the factory operating schedule. Thereafter, the faulty car of the train 100 is transported to the maintenance factory 4 for its repair. The failure occurrence is previously transmitted quickly to the factory and then various information on the failure are also previously transmitted thereto, before the actual car transportation to the factory. As a result, the factory can conduct the repair efficiently. Further, the actual failure state and normal state information previously transmitted to the factory may be stored as a database. This can facilitate estimation of a failure cause or repairing works when a similar failure next takes place.

In the foregoing embodiment, even a device manufacturer (not given) may be connected to this network. And by sending the same information transmitted to the maintenance factory 4 to the device manufacturers, the failure recovering works, such as arrangement of replacement parts, can be more efficiently advanced.

In this embodiment, information necessary for each of the communication parties is processed in the train and then transmitted. For this reason, the amount of information between the ground and train sides can be made remarkably smaller compared with the case that the information is transmitted without being processed. Accordingly it is unnecessarily to ensure a large capacity communication line. Further, since necessary information is directly sent to the ground facilities, there is no need to replace a necessary part from the received information and thus a large-scale information processing system is not required.

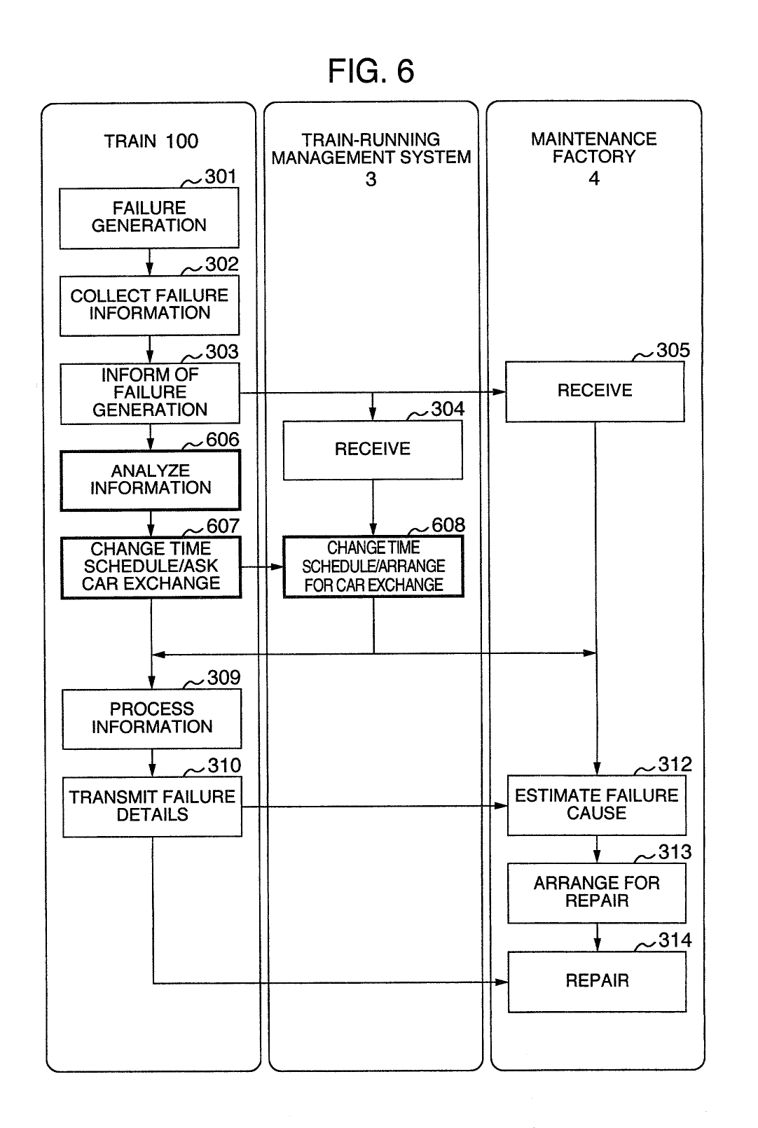

FIG. 6 shows a flowchart for explaining flows of operations of a train recovery support system in accordance with a second embodiment of the present invention point of failure. The present embodiment is different from the first embodiment in that the information analyzing units 221 and 222 in FIG. 2 are used and only steps 606 to 608 shown by bold lines in FIG. 6 are different.

To detect a failure in the train 100 and broadcast the fact to the train-running management system 3 and maintenance factory 4 on the ground side, is same as that of the first embodiment. The train 100 analyzes the state of the failure and evaluates the influences of the failure such as the possibility of running the train on schedule in a step 606. If the train decides the extension of failure is light not to cause a delay, the train continues to run as it is, and requires the train-running management system to repair after completion of the service running. If the train decides that the extent of failure is heavy to cause a delay in the time schedule, the train requires the train-running management system 3 in a step 607 to change the time schedule and to replace the faulty car.

Unlike FIG. 3, the train-running management system 3 has not to analyse the failure state (step 308), but according to the command from the train 100, it adjusts the time schedule, issues a command to later trains and stations to arrange car replacement in a step 608. And the train-running management system 3 requires the maintenance factory 4 repair.

The procedure of the train and the maintenance factory 4 are the same as those in the first embodiment. However, estimation 312 of the failure cause in the maintenance factory 4 may be carried out on the train and only the estimation result may be transmitted to the maintenance factory 4. In this case, it becomes necessary to form a database about past failure information in the train, but instead the amount of information can be largely reduced.

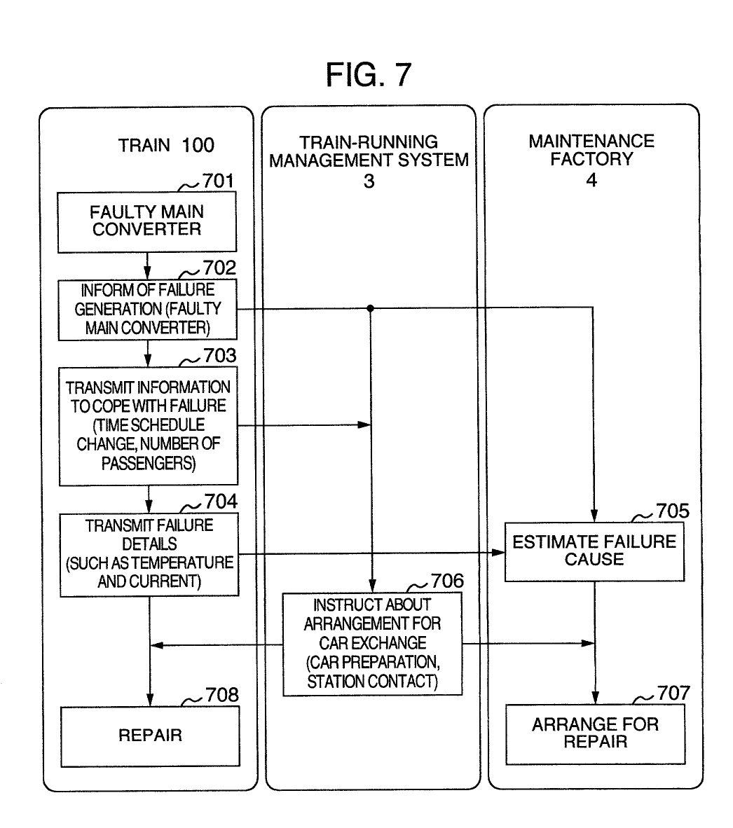

FIG. 7 shows an example of a flowchart of specific operations of the second embodiment of the present invention point of failure. It is now assumed as in the first embodiment that one of four main converters mounted on a train stopped its operation due to a temperature failure and the train running operation was influenced by it in a step 701. As soon as the train 100 detects the failure, the train sends the notification that the main converter breaks down to the command functions of the train-running management system 3 and maintenance factory 4 (in a step 702). In response to the notification, the command functions of the train-running management system 3 and maintenance factory 4 arrange to cope with the failure, which is the same as in the first embodiment, except that the train 100 analyzes collected information. In this example, assuming that the train decides that the normal running of the train 100 is impossible, then the train requires the train-running management system 3 to change its time schedule and to replace the faulty car, or transmits the information about the number of passengers estimated from the weight of the faulty car thereto in a step 703. At the request of the train 100, the train-running management system 3 selects a station wherein the car is replaced according to the degree of train delay and the required time to arrange the replace car, and contacts with the train in a step 706. Simultaneously with it, the train-running management system 3 sends the information to the maintenance factory 4 about the arriving time of the faulty car 100 to the maintenance factory 4. And the train-running management system 3 instructs later trains the time schedule change. Further, the train-running management system 3 also supports by contacting with the station wherein the car is replaced and telling the number of passengers on the car to realize smooth car replacement.

The following operations of the maintenance factory 4 are exactly the same as in the first embodiment.

In the second embodiment, in addition to the effects of the first embodiment, information analysis is carried out on the train so that the amount of communication between the ground and train sides can be made less, and a necessary command can be sent to the ground facilities, thus requiring a less amount of deciding operation. Further, since information is processed after analyzed, the amount of information to be transmitted to the ground facilities can be made less.

In accordance with the present invention, since information necessary for each of the ground facilities is processed and then transmitted from the train to the ground side, the transmission system can be made small in scale. Since only necessary information is transmitted to the receiving facilities, the need for the receiving facilities to have a large processing capacity for information extraction and analysis can be eliminated.

What is claimed is:

1. A support system for recovering a train, comprising:
a train;
a train-running management system installed on a ground side;
a train maintenance factory installed on the ground side;
means mounted on said train for collecting information on states of devices mounted on the train;
a communication line for transmitting the collected information to said train-running management system and maintenance factory;
means for processing said collected information according to communication parties in the train; and
a communication device for transmitting said different processed information to said corresponding train-running management system and maintenance factory.

2. A support system for recovering a train, comprising:
a train;
a train-running management system installed on a ground side;
a train maintenance factory installed on the ground side;
means mounted on said train for collecting information on states of devices mounted on said train;
a communication line for transmitting the collected information to said train-running management system and maintenance factory respectively;
an information analysis device mounted on said train for analyzing the influence of a failure on running operation of the train;
means for processing said collected information according to different communication parties; and
a communication device for transmitting said analyzed information and/or said different processed information to said corresponding train-running management system or maintenance factory respectively.

3. A support system as set forth in claim 1, wherein a communication device of a manufacturer of the devices mounted on said train is connected to said communication line.

4. A support system as set forth in claim 2, wherein a communication device of a manufacturer of the devices mounted on said train is connected to said communication line.

5. An information transmission system on a train, comprising:
a transmission line provided in an interior of said train;
devices mounted on the train and connected to said transmission line for outputting information on their own states to the transmission line;
means connected to said transmission line for collecting the state information of said train-mounted devices;
a communication device for transmitting the information to facilities installed on a ground side;
means for processing said state information according to communication parties; and
means for transmitting the processed information.

6. An information transmission system on a train, comprising:
a transmission line provided in an interior of said train;
devices mounted on the train and connected to said transmission line for outputting information on their own states to the transmission line;
means connected to said transmission line for collecting the state information of said train-mounted devices;
a communication device for transmitting the information to facilities installed on a ground side;
means for processing said state information according to communication parties;
means for analyzing said state information; and
means for transmitting the processed information and/or said analyzed information.

7. A method in a train recovery support system for transmitting information about a failure generated in a train from the train to ground facilities on a ground side, said system comprising:
the train;
a train-running management system installed on the ground side;
a train maintenance factory installed on the ground side;
means mounted in an interior of the train for collecting information on states of devices mounted on the train; and
a communication line for transmitting said collected information to said train-running management system and maintenance factory,
said method comprising the steps of:
when a failure took place in said train, transmitting the fact toward a plurality of said ground facilities;
processing said collected information according communication parties; and
transmitting said processed information to said plurality of corresponding ground facilities.

8. A method in a train recovery support system for transmitting information about a failure generated in a train from the train to ground facilities on a ground side, said system comprising:
the train;
a train-running management system installed on the ground side;
a train maintenance factory installed on the ground side;
means mounted in an interior of the train for collecting information on states of devices mounted on the train; and
a communication line for transmitting said collected information to said train-running management system and maintenance factory,
said method comprising the steps of:
when a failure took place in said train, transmitting the fact toward a plurality of said ground facilities;
analyzing the influence of said failure on running operation of the train;
processing said collected information according communication parties; and
transmitting said analyzed information and/or said different processed information to said plurality of corresponding ground facilities.

9. A method in a train recovery support system for transmitting information about a failure generated in a train from the train to ground facilities on a ground side, said system comprising:
the train;
a train-running management system installed on the ground side;
a train maintenance factory installed on the ground side;
means mounted in an interior of the train for collecting information on states of devices mounted on the train; and
a communication line for transmitting said collected information to said train-running management system and maintenance factory,
said method comprising the steps of:
when a failure took place in said train, transmitting the fact toward a plurality of said ground facilities;
analyzing said collected information;
processing said analyzed information according to communication parties; and
transmitting said different processed information to said plurality of corresponding ground facilities.
